(19) United States
(12) Patent Application Publication
(10) Pub. No.: US 2023/0125400 A1
(43) Pub. Date: Apr. 27, 2023

(54) ELECTRONIC DEVICE AND MANUFACTURING METHOD OF THE SAME

(71) Applicant: InnoLux Corporation, Miao-Li County (TW)

(72) Inventors: Chin-Lung TING, Miao-Li County (TW); Yu-Chun FU, Miao-Li County (TW); Cheng-Yang TSAI, Miao-Li County (TW)

(21) Appl. No.: 17/936,545

(22) Filed: Sep. 29, 2022

Related U.S. Application Data
(60) Provisional application No. 63/271,253, filed on Oct. 25, 2021.

(30) Foreign Application Priority Data
Aug. 5, 2022 (CN) 202210936434.7

(51) Int. Cl. G02B 1/11; G02B 1/14; G02B 1/18

(52) U.S. Cl. CPC G02B 1/11; G02B 1/14; G02B 1/18

(57) ABSTRACT

An electronic device includes an electronic module, a protective substrate on the electronic module, and a functional layer on the protective substrate. The functional layer has a hardness in a range of 4H to 9H. A manufacturing method of the electronic device comprises providing a protective substrate having a first surface and a second surface opposite to the first surface; forming a preparatory layer on the first surface; performing a heat treatment to convert the preparatory layer to a functional layer; and disposing an electronic module on the second surface, wherein the heat treatment is performed in a range of 200° C. to 1200° C.

### CROSS REFERENCE TO RELATED APPLICATIONS

This application claims the benefit of U.S. Provisional Application No. 63/271,253, filed Oct. 25, 2021, and China Patent Application No. 202210936434.7, filed on Aug. 5, 2022, the entirety of which is incorporated by reference herein.

### BACKGROUND OF THE INVENTION

### Field of the Invention

The present invention is related to an electronic device and manufacturing method of the same. In particular, it is related to an electronic device comprising a protective substrate and a functional layer and manufacturing method of the same.

### Description of the Related Art

The performance of electronic modules in electronic devices may be adversely affected when the electronic modules are physically or mechanically damaged. In order to protect electronic modules in electronic devices from physical and mechanical damage, it is necessary to increase the hardness and/or wear resistance of the surfaces of the electronic modules.

### BRIEF SUMMARY OF THE INVENTION

In view of the above problem, the present disclosure provides an electronic device and a manufacturing method thereof, wherein the electronic device comprises a protective substrate.

An embodiment of the present invention provides an electronic device, comprising: an electronic module; a protective substrate disposed on the electronic module; and a functional layer disposed on the protective substrate, wherein the functional layer has a hardness in a range of 4H to 9H.

An embodiment of the present invention provides a manufacturing method of an electronic device. The manufacturing method comprises providing a protective substrate having a first surface and a second surface opposite to the first surface; forming a preparatory layer on the first surface; performing a heat treatment to convert the preparatory layer to a functional layer; and disposing an electronic module on the second surface, wherein the heat treatment is performed at a temperature of 200° C. to 1200° C.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flowchart illustrating a manufacturing method of an electronic device according to some embodiments of the present disclosure.

FIGS. 2A to 2H illustrates cross-sectional views of intermediate structures of the electronic device corresponding to the stages of each step in the manufacturing method of the electronic device shown in FIG. 1.

FIG. 3 is a flowchart illustrating a manufacturing method of an electronic device according to some embodiments of the present disclosure.

FIGS. 4A to 4G illustrates cross-sectional views of intermediate structures of the electronic device corresponding to the stages of each step in the manufacturing method of the electronic device shown in FIG. 3.

FIG. 5 is a flowchart illustrating a manufacturing method of an electronic device according to some embodiments of the present disclosure.

FIGS. 6A to 6G illustrates cross-sectional views of intermediate structures of the electronic device corresponding to the stages of each step in the manufacturing method of the electronic device shown in FIG. 5.

FIG. 7 is a flowchart illustrating a manufacturing method of an electronic device according to some embodiments of the present disclosure.

FIGS. 8A to 8G illustrates cross-sectional views of intermediate structures of the electronic device corresponding to the stages of each step in the manufacturing method of the electronic device shown in FIG. 7.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

Throughout the present specification and the appended claims, certain terms may be used to refer to specific elements. It should be understood by those skilled in the art that the same elements may be referred to by different names. The present disclosure does not intend to distinguish between those elements that have the same function but have different names. In the specification and claims below, the words “comprises” and “includes” are open-ended terms and should therefore be interpreted to mean “comprises but not limited to . . . ”.

It should be understood that the use of ordinal terms such as “first”, “second”, etc., in the specification and claims to modify an element does not by itself connote any priority, precedence, or order of one claim element over another or the temporal order in which it is formed, but are used merely as labels to distinguish one claim element having a certain name from another element having the same name to distinguish the claim elements. Therefore, the first element in the specification may be referred as the second element in the claims.

Directional terms mentioned in the following examples, such as: up, down, left, right, front or back, etc., are only references to the directions in the attached drawings. Accordingly, the directional terms used are for illustrative purposes and are not intended to limit the present disclosure. It is important to understand that the components specifically described or illustrated may exist in various forms known to those of skill in the art. In the disclosure, when an element is referred to as “overlapping” with another element, it is understood that said element is partially overlapping or completely overlapping with said other element.

Some embodiments of the disclosure are described. Additional operations can be provided before, during, and/or after the steps described in these embodiments. Some of the steps that are described can be replaced or eliminated for different embodiments. Although some embodiments are discussed with steps performed in a particular order, these steps may be performed in another logical order.

Furthermore, when an element or layer is referred to as being “on,” or “connected to,” another element or layer, it may be directly on or connected to the other element or layer or intervening elements or layers may be present (in the examples which are indirectly on or connected to). When, however, an element or layer is referred to as being “directly on,” or “directly connected to,” another element or layer, there are no intervening elements or layers present. When an element or layer is referred to as being “coupled to” another element or layer, it may include the case where “the element is electrically connected to another element with intervening elements may be present” or the case where “the element is directly electrically connected to another element with no intervening elements present”. When an element is referred to as being “directly coupled to” another element, it refers to the case where “the element is directly electrically connected to another element with no intervening elements present”.

It will be understood that, the term “about”, “substantially”, as used herein usually indicates a value of a given value or range that varies within 10%, within 5%, within 3%, within 2%, within 1%, or within 0.5%. The value given here are approximate value, i.e., “about”, or “substantially”, may be implied without specifying “about”, or “substantially”. It will be further understood that the expression “value a-value b” used herein to indicate a specific range including the said value a, value b, and values between thereof.

Unless otherwise defined, all terms (including technical and scientific terms) used herein have the same meaning as commonly understood by a person skilled in the art to which the disclosure pertains. It will be further understood that terms, such as those defined in commonly used dictionaries, should be interpreted as having a meaning consistent with the relevant technology and the context or background of this disclosure and will not be interpreted in an idealized or overly formal sense unless expressly so defined herein.

The electronic device of the present disclosure may comprise a display device, an antenna device, a sensing device, a touch display, a packaging device, a curved display, or a free shape display, but not limited thereto. The electronic device may be a bendable or flexible electronic device. The antenna device maybe, for example, a liquid crystal antenna, but not limited there to. The antenna device may include, for example, an antenna splicing device, but is not limited thereto. The packaging device may be used for Wafer-Level Package (WLP) technology or Panel-Level Package (WLP) technology, such as chip first or RDL first processes. It should be noted that the electronic device may be, but not limited to, any combination of the aforementioned devices. In addition, a shape of the electronic device may be a rectangle, a circle, a polygon, a shape with curved edges, or other suitable shape. The electronic device may include electronic elements. The electronic elements may include passive elements and/or active elements, such as capacitors, resistors, inductors, diodes, transistors, etc. The diodes may include light-emitting diodes or photoelectric diodes. The light-emitting diodes may include, for example, organic light-emitting diodes (OLED), mini light-emitting diodes (mini LED), micro light-emitting diodes (micro LED), or quantum dot light-emitting diodes (quantum dot LED), but not limited to thereof. The electronic devices may have peripheral systems such as drive systems, control systems, light source systems, shelf systems, etc. to support the display device, antenna device, or splicing device.

The electronic device of the present disclosure comprises a substrate assembly and an electronic module. The substrate assembly of the present disclosure comprises a protective substrate and a functional layer formed on the protective substrate. The electronic module of the present disclosure refers to modules of the electronic device described above that is used to perform the desired function. For example, the electronic module in this disclosure may comprise a display module, an antenna module, a sensing module, a touch electronic module, a packaging module, a curved electronic module, or a free shape electronic module, but not limited thereto. The electronic module may include electronic elements. The electronic module may have peripheral systems such as drive systems, control systems, light source systems, shelf systems, etc. to support the display module, antenna module, or splicing module.

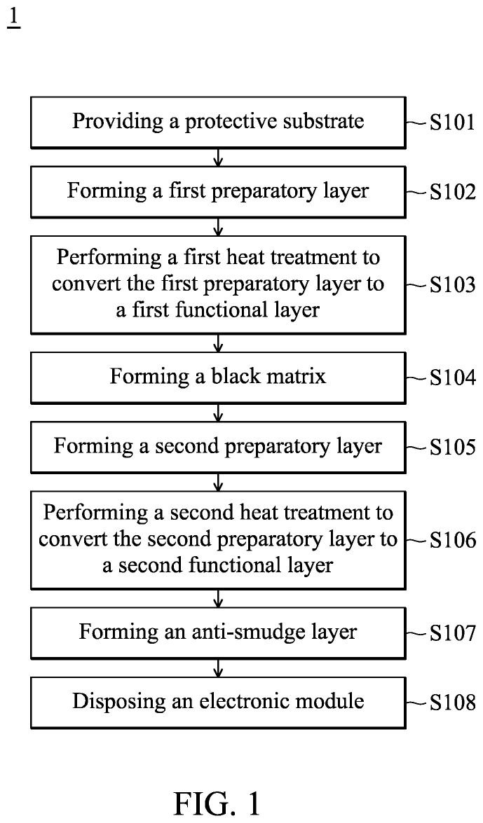

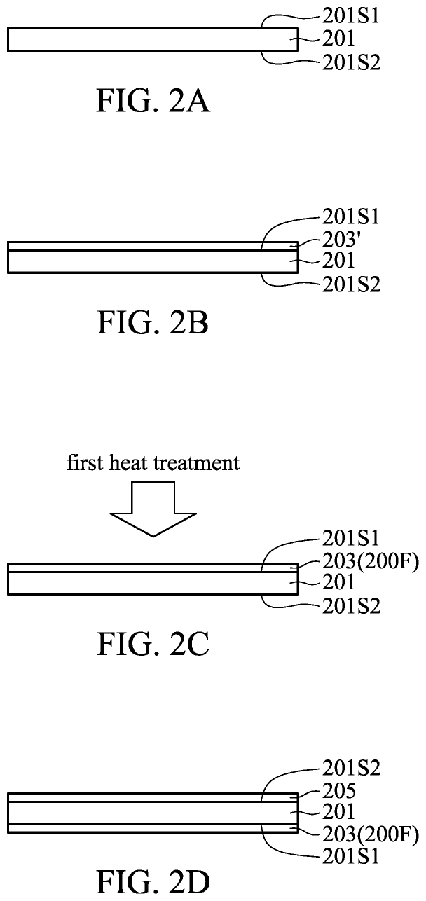

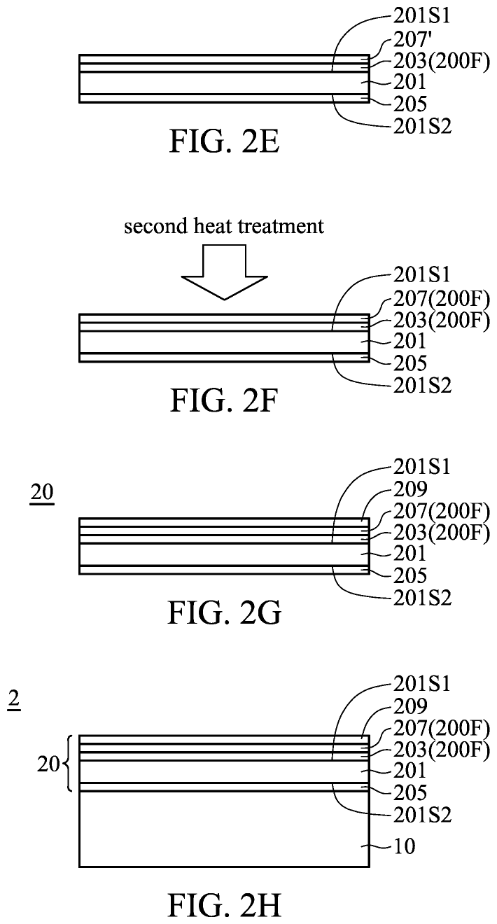

FIG. 1 is a flowchart illustrating a manufacturing method 1 of an electronic device according to some embodiments of the present disclosure. FIGS. 2A to 2H illustrates cross-sectional views of intermediate structures of a electronic device 2 corresponding to the stages of each step in the manufacturing method 1 of the electronic device 2 shown in FIG. 1. Hereinafter, the present disclosure will be described with reference to FIG. 1 and FIGS. 2A to 2H.

As shown in FIG. 2H, the electronic device 2 comprises an electronic module 10, a protective substrate 201, and a functional layer 200F. The functional layer 200F is disposed on the protective substrate 201, and the hardness of the functional layer 200F is in a range of about 4H to 9H. According to some embodiments, the functional layer 200F may comprise at least one layer, or may be multiple layers. According to some embodiments, as shown in FIG. 2H, the functional layer 200F may comprise a first functional layer 203(200F) and a second functional layer 207(200F). The second functional layer 207(200F) may be disposed above the first functional layer 203(200F). According to some embodiments, the functional layer 200F may comprise a first functional layer 203(200F). According to some embodiments, the functional layer 200F may comprise a second functional layer 207(200F). According to some embodiments, the functional layer 200F may be a single layer. According to some embodiments, the functional layer 200F may have a density of about 1.3 to 4.6 g/cm³. According to some embodiments, the functional layer 200F may comprises an anti-glare layer, an anti-reflective layer, or a combination thereof, but the present disclosure is not limited thereto. According to some embodiments, the functional layer 200F may have a hardness (pencil hardness) in a range of about H to 9H, for example, from about H to 5H, from about 3H to 5H, from about 4H to 9H, from about 5H to 9H, from about 6H to 9H, or from about 6H to 8H. According to some embodiments, the functional layer 200F may comprise a first functional layer 203(200F), but not a second functional layer 207(200F). According to some embodiments, the functional layer 200F may comprise a second functional layer 207(200F), but not a first functional layer 203(200F). According to some embodiments, the physical properties (e.g., hardness) of the functional layer 200F may be obtained by measuring the physical properties (e.g., hardness) of the entire functional layer 200F. According to some embodiments, the physical properties (e.g., hardness) of the functional layer 200F may be obtained by measuring the physical properties (e.g., hardness) of one of the layers of the functional layer 200F. For example, the physical properties (e.g., hardness) of the functional layer 200F may be obtained by measuring the physical properties (e.g., hardness) of the outermost layer of the functional layer 200F (the layer furthest from the protective substrate 201).

As shown in FIG. 1, the manufacturing method 1 of an electronic device according to some embodiments of the present disclosure comprises step S101 of providing a protective substrate. As shown in FIG. 2A, the protective substrate 201 has a first surface 201S1 and a second surface 201S2 opposite to the first surface 201S1. The manufacturing method 1 also comprises step S102 of forming a first preparatory layer on the first surface 201S1, step S103 of performing a first heat treatment to convert the first preparatory layer to a first functional layer, step S104 of forming a black matrix, step S105 of forming a second preparatory layer, step S106 of performing a second heat treatment to convert the second preparatory layer to a second functional layer, step S107 of forming an anti-smudge layer, and step S108 of disposing an electronic module on the second surface 201S2. According to some embodiments, as shown in FIG. 1, the manufacturing method 1 of an electronic device comprises step S101 of providing a protective substrate, step S102 of forming a preparatory layer (e.g., the first preparatory layer) on the first surface 201S1, step S103 of performing a heat treatment (e.g., the first heat treatment) to convert the preparatory layer to a functional layer (e.g., the first functional layer), and step S108 of disposing an electronic module on the second surface 201S2. The heat treatment (e.g., the first heat treatment and/or the second treatment) may be performed at a temperature of 200° C. to 1200° C. According to some embodiments, for example, the heat treatment may be performed at a temperature of 200° C. to 500° C., of 200° C. to 300° C., of 250° C. to 300° C., of 250° C. to 600° C., or of 600° C. to 1200° C.

FIG. 2A is a cross-sectional view illustrating the intermediate structure of the electronic device 2 at the stage of step S101 in the manufacturing method 1 of the electronic device. The protective substrate provided in step S101 may comprise a flexible substrate, a rigid substrate, or a combination thereof, but the present disclosure is not limited thereto. In some embodiments, the protective substrate may be a translucent substrate or a semi-translucent substrate. In some embodiments, the protective substrate may comprise glass, quartz, sapphire, ceramic, polyimides (PI), polycarbonates (PC), polyethylene terephthalates (PET), polypropylenes (PP), other suitable materials, or any combination thereof, but the present disclosure is not limited thereto. Examples of glass may comprise, but not limited to, oxide glass, fluoride glass, nitrogen oxide glass, sulfur glass, metallic glass, nitrate glass, and/or sulfate glass. Examples of oxide glass may comprise, but not limited to, silicate glass, borate glass, borax glass, aluminosilicate glass, phosphate glass, germanium silicate glass, lead glass, and/or soda lime glass. In embodiments in which the protective substrate comprises glass, step S101 of providing the protective substrate may further comprise a grinding step for grinding the protective substrate and a strengthening step for strengthening the protective substrate. The strengthening step may comprise a chemical strengthening process and/or a physical strengthening process. In some embodiments, step S101 of providing the protective substrate may further include a cutting step of cutting a mother substrate to a substrate with desired size and shape. In some embodiments, step S101 of providing the protective substrate may comprise one or more of the cutting step, the grinding step, and the strengthening step. For example, step S101 of providing the protective substrate may include a cutting step of cutting an aluminosilicate glass mother substrate with a thickness of about 0.7-2.0 mm into an aluminosilicate glass substrate with a desired size and shape; a grinding step of grinding the aluminosilicate glass substrate; and a strengthening step of immersing the ground aluminosilicate glass substrate in a KNO₃ solution, 99% purity, at a temperature of about 390-450° C. for about 30 minutes-10 hours to form a compressive stress layer in the surface of the aluminosilicate glass substrate. The depth of the compressive stress layer (DOL) is about 10-50 μm and the compressive stress value (CS) of the compressive stress layer is about 500-1200 Mpa. In some embodiments, the protective substrate 201 provided in step S101 may be a flat substrate as shown in FIG. 2A. The protective substrate 201 has a first surface 20151 and a second surface 20152 opposite to the first surface. The radius of curvature of the first surface 201S1 and the second surface 201S2 may both be 0, but the present disclosure is not limited thereto. In some embodiments, the radius of curvature of one or both of the first surface 201S1 or the second surface 201S2 may not be 0.

FIG. 2B is a cross-sectional view illustrating the intermediate structure of the electronic device 2 at the stage of step S102 in the manufacturing method 1 of the electronic device. Step S102 comprises forming a first preparatory layer 203′ on the first surface 20151 of the protective substrate 201 obtained in step S101, as shown in FIG. 2B. The first preparatory layer 203′ in this disclosure refers to a material layer that will form a first functional layer 203(200F) in a subsequent heat treatment. In some embodiments, the first functional layer 203(200F) may comprise, but not limited to, an anti-glare layer, an anti-reflective layer, or a combination thereof. In some embodiments, the first functional layer 203(200F) comprises an anti-glare layer. In some embodiments, the first preparatory layer 203′ comprises an oxide layer. In some embodiments, the first preparatory layer 203′ comprises silicon oxide (SiO₂). In some embodiments, the first preparatory layer 203′ may be formed on the first surface 201S1 of the protective substrate 201 by a needle coating process, a spray coating process, an Ink-Jet printing coating process, a screen printing coating process, a relief/gravure printing coating process, a transfer printing coating process, a chemical vapor deposition (CVD) process, a physical vapor deposition (PVD) process, an atomic layer deposition (ALD) process, a high density plasma chemical vapor deposition (HDPCVD) process, other suitable processes or a combination thereof, but the present disclosure is not limited thereto. In some embodiments, the first preparatory layer 203′ is in direct contact with the first surface 201S1 of the protective substrate 201. In some embodiments, the first preparatory layer 203′ may not be in direct contact with the first surface 201S1 of the protective substrate 201. For example, in some embodiments, step S102 of forming the first preparatory layer comprises forming silicon oxide (SiO₂) on the protective substrate 201 as the first preparatory layer 203′ by a spraying process. The spraying process comprises a spraying temperature of about 200 to 300° C. and a process time of about 30 minutes to 120 minutes. A silicon oxide (SiO₂) layer is formed on the first surface 20151 of the protective substrate 201 as the first preparatory layer 203′. The thickness of the first preparatory layer 203′ may be in a range of about 10 nm to 10 μm (micrometer), e.g., from about 100 to 500 nm.

FIG. 2C is a cross-sectional view illustrating the intermediate structure of the electronic device 2 at the stage of step S103 in the manufacturing method 1 of the electronic device. The first preparatory layer 203′ formed in step S102 may be converted to a first functional layer 203(200F), such as an anti-glare layer, an anti-reactive layer, or a combination thereof, after performing the first heat treatment in step S103. The physical properties of the first preparatory layer 203′ may change after a heat treatment. For example, in some embodiments, after the heat treatment, a hardness of the first functional layer 203(200F) may be higher than that of the first preparatory layer 203′. For example, before the heat treatment, the hardness of the first preparatory layer 203′ may be in a range of about 3H to 5H. After the heat treatment, the first functional layer 203(200F) may have a hardness in a range of about 4H to 9H, such as about 5H to 9H, or about 6H to 9H. In some embodiments, after the heat treatment, the density of the first functional layer 203(200F) may be higher than that of the first preparatory layer 203′. For example, before the heat treatment, the density of the first preparatory layer 203′ may be in a range of about 1.3 to about 2.3 g/cm³, such as from about 1.3 to about 1.9 g/cm³. After the heat treatment, the density of the first functional layer 203(200F) may be in a range from about 1.3 to 2.7 g/cm³, e.g., from about 2.0 to 2.7 g/cm³, or from about 2.3 to 2.7 g/cm³.

In some embodiments, the first functional layer 203(200F) has a hardness in a range of about 4H to 9H, a thickness of about 10 nm to 10 μm, a density of about 1.3 to 2.7 g/cm³, and/or a porosity of about 10 to 90%. In some embodiments, the first functional layer 203(200F) has a hardness in a range between about 6H to 9H, a thickness of about 100 to 500 nm, a density of about 1.3 to 2.3 g/cm³, and/or a porosity of about 10 to 90%. In some embodiments, the density of the first functional layer 203(200F) may be in a range from about 1.3-2.7 g/cm³, for example, from about 1.3-2.3 g/cm³, or from about 1.3-1.9 g/cm³. In some embodiments, a porosity of the first functional layer 203(200F) may be in a range of about 10-90%, about 10-70%, about 10-50%, about 10-30%, about 10-20%, about 20-80%, about 20-50%, about 20-30%, such as from about 40-80%, or from about 60 to about 85%. In some embodiments, a glossiness of the first functional layer 203(200F) may be in a range of about 40 to 140 GU, such as from about 60 to 140 GU, from about 40 to 120 GU, from about 80 to 130 GU, or from about 60 to 110 GU. In some embodiments, the reflectivity of the first functional layer 203(200F) may be in a range from about 0.1 to 9%, e.g., from about 0.1 to 6.1%, from about 0.1 to 5.1%, from about 1 to 9%, from about 3 to 9%, or from about 2 to 5%. According to some embodiments, the porosity of the first preparatory layer 203′ may change after the heat treatment. For example, in some embodiments, after the heat treatment, the porosity of the first functional layer 203 may lower than that of the first preparatory layer 203′. For example, the porosity of the first preparatory layer 203′ may be in a range of about 75 to 90% before the heat treatment, and the porosity of the first functional layer 203 may be in a range of 10 to 70% after the heat treatment.

In some embodiments, the heat treatment (e.g., the first heat treatment) may comprise an annealing process. For example, the annealing process is a process that performs high temperature treatments at specific regions. The process temperature of the annealing process may be adjusted according to the recrystallization temperature of the object to be annealed. For example, in the embodiment where the first preparatory layer 203′ comprises silicon oxide (SiO₂), the first heat treatment in step S103 may be carried out by performing an annealing process at a process temperature of 200° C. to 1200° C., such as 600° C. to 1200° C., for 0.01 minutes to 10 minutes. According to some embodiments, the first heat treatment may be performed at a process temperature in a range of 200° C. to 500° C., for example, in a range of 250° C. to 300° C. Examples of the annealing processes may comprise a laser annealing process, a rapid annealing process, a plasma annealing process, an optical annealing process, a fluid annealing process, or a combination thereof, but the disclosure is not limited thereto. The fluid annealing process may comprise a hot-fluid annealing process, but the disclosure is not limited thereto. The optical annealing processes comprise a UV annealing process, a focused infrared annealing process, or a combination thereof. The rapid annealing process may be a rapid thermal annealing (RTA) process. In some embodiments, the first heat treatment may comprise a laser annealing process.

FIG. 2D is a cross-sectional view illustrating the intermediate structure of the electronic device 2 at the stage of step S104 in the manufacturing method 1 of the electronic device. In step S104, a black matrix 205 is formed on the second surface 201S2 of the protective substrate 201. The protective substrate 201 is between the black matrix 205 and the first functional layer 203(200F), as shown in FIG. 2D. In some embodiments, the black matrix 205 may comprise resins, pigments, dyes, additives, or any combination thereof. In some embodiments, the pigments may comprise a carbon black, an ink, or a combination thereof. In some embodiments, the black matrix 205 may be formed on the second surface 201S2 of the protective substrate 201 by a needle coating process, a spray coating process, an Ink-Jet printing coating process, a screen printing coating process, a relief/gravure printing coating process, a transfer printing coating process, a chemical vapor deposition (CVD) process, a physical vapor deposition (PVD) process, an atomic layer deposition (ALD) process, a high density plasma chemical vapor deposition (HDPCVD) process, other suitable processes or a combination thereof, but the present disclosure is not limited thereto. In some embodiments, the black matrix 205 is in direct contact with the second surface 201S2 of the protective substrate 201. In some embodiments, the black matrix 205 may not be in direct contact with the second surface 201S2 of the protective substrate 201. For example, in some embodiments, step S104 of forming the black matrix may comprise a spraying process using a spraying temperature of about 80 to 300° C. for about 30 minutes to 120 minutes to form the black matrix 205 on a second surface 201S2 of the protective substrate 201. In the figures of the disclosure, the black matrix 205 is shown in a single layer for simplicity. However, according to some embodiments, the black matrix 205 may have a pattern, e.g., a black matrix pattern, and the black matrix 205 may be disposed on the periphery of the protective substrate 201 and serve as a decorative layer on the periphery of the protective substrate 201.

FIG. 2E is a cross-sectional view illustrating the intermediate structure of the electronic device 2 at the stage of step S105 in the manufacturing method 1 of the electronic device. In step S105, the second preparatory layer 207′ is formed on the first surface 201S1 of the protective substrate 201. The first functional layer 203(200F) is between the second preparatory layer 207′ and the protective substrate 201, as shown in FIG. 2E. The second preparatory layer 207′ in the disclosure refers to a material layer that will form a second functional layer 207(200F) in a subsequent heat treatment. In some embodiments, examples of the second functional layer 207(200F) may comprise, but not limited to, an anti-glare layer, an anti-reflective layer, or a combination thereof. The second functional layer 207(200F) may be the same as or different from the first functional layer 203(200F). In some embodiments, the second functional layer 207(200F) comprises an anti-reflective layer. In some embodiments, the second preparatory layer 207′ comprises an oxide layer. In some embodiments, the second preparatory layer 207′ comprises silicon oxide (SiO₂) and niobium oxide (Nb₂O₅). In some embodiments, the second preparatory layer 207′ may be formed on the first surface 201S1 of the protective substrate 201 by a needle coating process, a spray coating process, a spray evaporation process, an Ink-Jet printing coating process, a screen printing coating process, a relief/gravure printing coating process, a transfer printing coating process, a chemical vapor deposition process, a physical vapor deposition process, an atomic layer deposition process, a high density plasma chemical vapor deposition process, other suitable processes or a combination thereof, but the present disclosure is not limited thereto. In some embodiments, the second preparatory layer 207′ is in direct contact with the first functional layer 203(200F). In some embodiments, the second preparatory layer 207′ may not be in direct contact with the first functional layer 203(200F). For example, in some embodiments, step S105 of forming the second preparatory layer comprises forming a mixture of silicon oxide (SiO₂) and niobium oxide (Nb₂O₅) with a thickness of about 10 nm to 10 μm on the first functional layer 203(200F) as the second preparatory layer 207′ by a spray evaporation process. The spray evaporation process comprises a process temperature of about 100 to 200° C. and a process time of about 30 minutes to 120 minutes.

FIG. 2F is a cross-sectional view illustrating the intermediate structure of the electronic device 2 at the stage of step S106 in the manufacturing method 1 of the electronic device. The second preparatory layer 207′ formed in step S105 may be converted to a second functional layer 207(200F), such as an anti-glare layer, an anti-reactive layer, or a combination thereof, after performing the second heat treatment in step S106. The conditions of the second heat treatment can be referred to the first heat treatment above and will not be repeated here. In some embodiments, the second heat treatment may comprise an annealing process. The annealing process is a process that performs high temperature treatments at specific regions so that damages to other material layers, e.g., the black matrix 205 formed on the second surface 20152 of the protective substrate 201 may be avoided. The process temperature of the annealing process may be adjusted according to the recrystallization temperature of the object to be annealed. For example, in the embodiment where second preparatory layer 207′ comprises a mixture of silicon oxide (SiO₂) and niobium oxide (Nb₂O₅), the second heat treatment in step S106 may be carried out by performing an annealing process at a process temperature in a range of 200° C. to 1200° C., such as 600° C. to 1200° C., for 0.01 minutes to 10 minutes. In some embodiments, the second heat treatment may comprise a laser annealing process. The conditions and types of the annealing process in the second heat treatment may refer to above and will not be repeated here.

The physical properties of the second preparatory layer 207′ may change after a heat treatment. For example, in some embodiments, after the heat treatment, a hardness of the second functional layer 207(200F) may be higher than that of the second preparatory layer 207′. For example, before the heat treatment, the hardness of the second preparatory layer 207′ may be in a range of about 3H to 8H, such as about 3H to 5H, or about 6H to 8H. After the heat treatment, the hardness of the second functional layer 207(200F) may be in a range of about 4H to 9H, such as about 5H to 9H, 7H to 9H, 8H to 9H, 6H to 9H, or about 6H to 8H. In some embodiments, after the heat treatment, a density of the second functional layer 207(200F) may be higher than that of the second preparatory layer 207′. For example, the density of the second functional layer 207(200F) may be in a range from about 1.3 to 2.3 g/cm³, or from about 1.3 to 2.7 g/cm³. In some embodiments, a porosity of the second functional layer 207(200F) may be about 10 to about 90%, such as about 40-80%, or about 60 to about 85%. In some embodiments, the second functional layer 207(200F) has a hardness in a range from about 4H to 9H, a thickness of about 10 nm to 10 μm, a density of about 1.3 to 2.3 g/cm³, and/or a porosity of about 10 to about 90%. In some embodiments, the second functional layer 207(200F) has a hardness in a range from about 6H to 9H, a thickness of about 10 nm to 10 μm, a density of about 1.3 to 2.7 g/cm³, and/or a porosity of about 10 to about 90%. In some embodiments, a glossiness of the second functional layer 207(200F) may be in a range from about 40 to 140 GU, such as from about 60 to 140 GU, from about 40 to 120 GU, from about 80 to 130 GU, or from about 60 to 110 GU. In some embodiments, the reflectivity of the second functional layer 207(200F) maybe in a range from about 0.1 to 9%, e.g., from about 0.1 to 6.1%, from about 0.1 to 5.1%, from about 1 to 9%, from about 3 to 9%, or from about 2 to 5%. The reflectivity of the second functional layer 207(200F) may be different from that of the first functional layer 203(200F). In some embodiments, the reflectivity of the second functional layer 207(200F) may be greater than that of the first functional layer 203(200F). In some embodiments, the reflectivity of the second functional layer 207(200F) may be smaller than that of the first functional layer 203(200F).

FIG. 2G is a cross-sectional view illustrating the intermediate structure of the electronic device 2 at the stage of step S107 in the manufacturing method 1 of the electronic device. In step S107, an anti-smudge layer 209 is formed on the second functional layer 207(200F). The second functional layer 207(200F) is between the anti-smudge layer 209 and the first functional layer 203(200F), as shown in FIG. 2G. In some embodiments, the anti-smudge layer 209 may comprise solvents and fluorides. Examples of the fluorides may comprise fluoropolymers, such as 1-ethoxy-1,1,2,2,3,3,4,4,4-nonafluoro-butane (C₄F₉OC₂H), 2-(ethoxydifluoromethyl)-1,1,1,2,3,3,3-heptafluoropropane (C₆H₅F₉O), or a combination thereof. In some embodiments, the anti-smudge layer 209 may be formed on the second functional layer 207(200F) by a needle coating process, a spray coating process, an Ink-Jet printing coating process, a screen printing coating process, a relief/gravure printing coating process, a transfer printing coating process, a chemical vapor deposition (CVD) process, a physical vapor deposition (PVD) process, an atomic layer deposition (ALD) process, a high density plasma chemical vapor deposition (HDPCVD) process, other suitable processes or a combination thereof, but the present disclosure is not limited thereto. In some embodiments, the anti-smudge layer 209 may be in direct contact with the second functional layer 207 (200F). In some embodiments, the anti-smudge layer 209 may not be in direct contact with the second functional layer 207 (200F). For example, in some embodiments, step S107 of forming the anti-smudge layer comprises forming a mixture of solvents and fluorides on the second functional layer 207 (200F) in a thickness of about 3 to 30 nm as the anti-smudge layer 209 by a spray evaporation process comprising a process temperature of about 100 to 200° C. and a process time of about 30 minutes to 120 minutes. A substrate assembly 20 comprising the protective substrate and the functional layer formed thereon is obtained after completing step S107. The substrate assembly 20 may have high hardness, good wear resistance and/or good impact resistance due to the high hardness, high density, low porosity of the first functional layer and the second functional layer. According to some embodiments, the anti-smudge layer 209 may have a water contact angle (WCA) greater than about 100 degrees, e.g., in a range of about 100 to 130 degrees, such as about 100 to 120 degrees, or about 100 to 110 degrees.

FIG. 2H is a cross-sectional view illustrating the intermediate structure of the electronic device 2 at the stage of step S108 in the manufacturing method 1 of the electronic device. As shown in FIG. 2H, in step S108, the electronic module 10 is disposed on the second surface 201S2 of the protective substrate 201. The black matrix 205 is between the protective substrate 201 and the electronic module 10. In step S108, the electronic module 10 may be disposed on the second surface 201S2 of the protective substrate 201 by laminating, but the present disclosure is not limited thereto. The electronic device 2 is obtained after completing step S108. The electronic device 2 comprises a substrate assembly 20 having high hardness, good wear resistance and/or good impact resistance. Therefore, the electronic module 10 in the disclosed electronic device 2 is less susceptible to damage than in the conventional electronic devices. The disclosed electronic device 2 may have a longer service life, better wear resistance, and/or better impact resistance. According to some embodiments, as shown in FIG. 2H, the functional layer 200F is in direct contact with the protective substrate 201 and there is no films and/or layers between the functional layer 200F and the protective substrate 201.

According to some embodiments, as shown in FIG. 2H, the functional layer 200F may comprise the first functional layer 203(200F) and the second functional layer 207(200F), and the second functional layer 207(200F) may be disposed on the first functional layer 203(200F). The first functional layer 203(200F) may be an anti-glare layer and the second functional layer 207(200F) may be an anti-reflective layer, but the present invention is not limited thereto. The first functional layer 203(200F) may be an anti-glare layer and the second functional layer 207(200F) may be an anti-reflection layer, but the invention is not limited to this. As shown in FIG. 2H, the electronic device may further comprise the anti-smudge layer 209, and the anti-smudge layer 209 may be disposed on the functional layer 200F.

In FIG. 2E, although the second preparatory layer 207′ is shown as one layer, the second preparatory layer 207′ may comprises more than one layer. In FIGS. 2F-2G, although the second functional layer 207(200F) is shown as one layer, the second functional layer 207(200F) may comprise more than one layer. For example, the second functional layer 207(200F) (or the second preparatory layer 207′) may be a stack of insulating layers with different refractive indices. For example, the second functional layer 207(200F) may comprise four layers (from bottom to top) of silicon oxide (SiO₂), niobium oxide (Nb₂O₅), silicon oxide, niobium oxide, etc. The physical properties of individual layers in the second preparatory layer 207′ may change after a heat treatment. For example, in some embodiments, the density and/or porosity of the silicon oxide may change after the heat treatment. For example, before the heat treatment, the density of the silicon oxide in the second preparatory layer 207′ may be in a range from about 1.3 to 2.3 g/cm³, e.g., from about 1.3 to 1.9 g/cm³. After the heat treatment, the density of silicon oxide in the second functional layer 207 (200F) may be in a range from about 1.3 to 2.7 g/cm³, for example, from about 1.5 to 2.3 g/cm³. In some embodiments, the porosity of the silicon oxide may change after the heat treatment. For example, before the heat treatment, the porosity of the silicon oxide in the second preparatory layer 207′ may be in a range from about 10 to about 90%, e.g., from about 40 to about 80%. After the heat treatment, the porosity of the silicon oxide in the second functional layer 207 (200F) may be in a range from about 30 to 90%, e.g., from about 30 to 70%. Similarly, in some embodiments, the density and/or porosity of the niobium oxide may change after the heat treatment. The density of the niobium oxide in the second functional layer 207(200F) may be in a range from about 3.5 to about 5 g/cm³, e.g., about 4.6 g/cm³. The porosity of niobium oxide in the second functional layer 207(200F) may be in a range from about 10 to 90%, e.g., from about 10 to 70%, from about 10 to 50%, from about 10 to 30%, from about 10 to 20%, from about 20 to 80%, from about 20 to 50%, from about 20 to 30%, from about 40 to 80%, from about 60 to 85%. According to some embodiments, the porosity of the second preparatory layer 207′ may change after the heat treatment. For example, in some embodiments, after the heat treatment, a porosity of the second functional layer 207 (200F) may be lower than that of the second preparatory layer 207′. For example, before the heat treatment, the porosity of the second preparatory layer 207′ may be in a range from about 75 to 90%, and after the heat treatment, the porosity of the second functional layer 207 (200F) may be in a range from 10 to 70%.

As mentioned above, in the electronic device disclosed herein, the functional layer is disposed on the protective substrate, and the hardness of the functional layer is in a range of about 4H-9H. In the manufacturing method of the electronic device of the present disclosure, the preparatory layer is converted into the functional layer after performing the heat treatment on the preparatory layer. The present disclosure provides a high hardness substrate assembly without affecting the existing equipment used to form the electronic device and adjusting the process parameters of the anti-smudge layer and/or anti-reflective layer. The present disclosure provides an electronic device that is impact resistant and/or has a long service life by forming the functional layer having a hardness in a range of about 4H to 9H on the protective substrate.

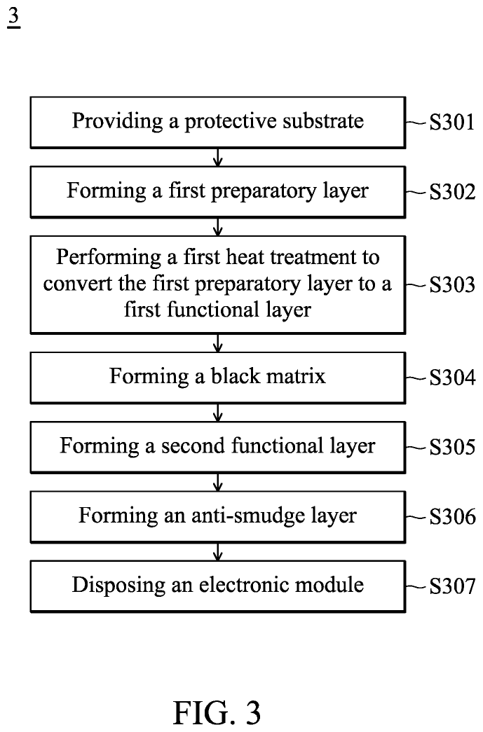

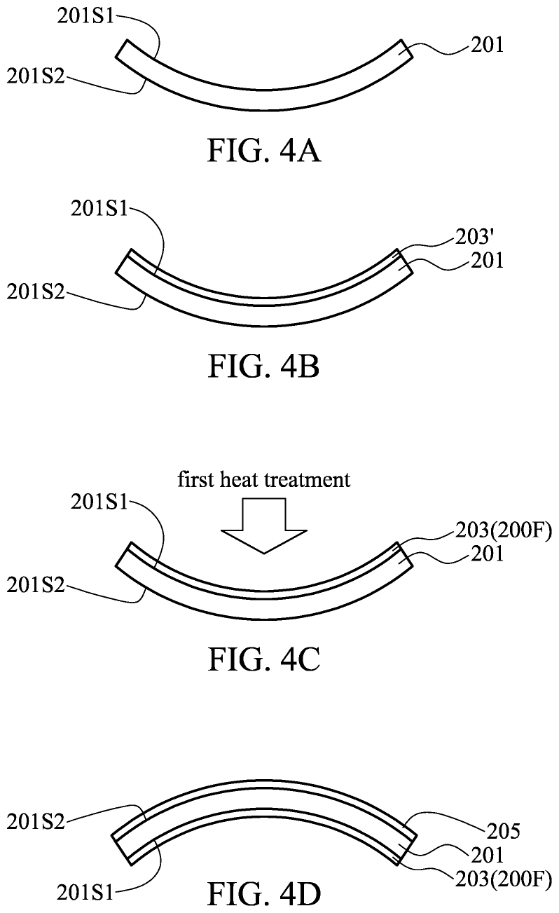

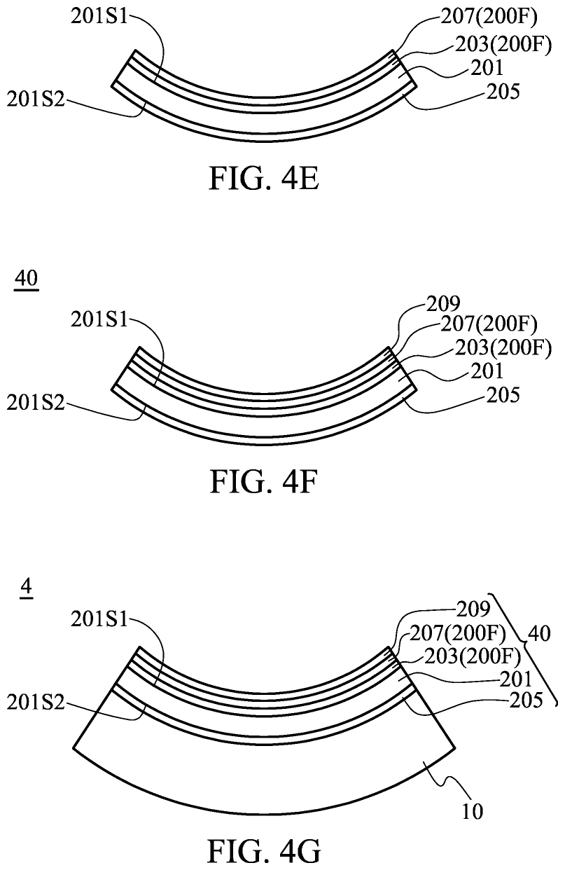

FIG. 3 is a flowchart illustrating a manufacturing method 3 of an electronic device according to some embodiments of the present disclosure. The manufacturing method of the electronic device shown in FIG. 3 is mainly different from the manufacturing method of the electronic device shown in FIG. 1 in that, in the manufacturing method of the electronic device shown in FIG. 3, the step of forming the second preparatory layer and the step of performing the second heat treatment step are replaced with the step of forming the second functional layer, and the step of providing the protective substrate 201 further comprises a shaping step to form the protective substrate into a curved shape in addition to the cutting step, the grinding step, and the strengthening step. The strengthening step may comprise a chemical strengthening process and/or a physical strengthening process. There is no limit on the execution sequence between the shaping step and the strengthening step. The shaping step may be performed before or after the strengthening step. FIGS. 4A to 4G illustrate cross-sectional views of intermediate structures of the electronic device 4 corresponding to the stages of each step in the manufacturing method 3 of the electronic device shown in FIG. 3. Hereinafter, the present disclosure will be described with reference to FIG. 3 and FIGS. 4A to 4G. The following mainly describes the main differences between this embodiment and the preceding embodiments. The descriptions of the same or similar elements can be referred to the preceding embodiment and will not be repeated here.

As shown in FIG. 3, the manufacturing method 3 of an electronic device according to some embodiments of the present disclosure comprises step S301 of providing a protective substrate, step S302 of forming a first preparatory layer, step S303 of performing a first heat treatment to convert the first preparatory layer to a first functional layer, step S304 of forming a black matrix, step S305 of forming a second functional layer, step S306 of forming an anti-smudge layer, and step S307 of disposing an electronic module.

FIG. 4A is a cross-sectional view illustrating the intermediate structure of the electronic device 4 at the stage of step S301 in the manufacturing method 3 of the electronic device. The protective substrate provided in step S301 may comprise the same or similar material as that of the protective substrate provided in step S101, so it is not repeated herein. In some embodiments, compared to step S101, step S301 may further comprise a shaping step to form the protective substrate into a curved shape. The shaping step may comprise a heat shaping process to shape the protective substrate from a flat sheet to a curved sheet by heating. For example, step S301 of providing the protective substrate may comprise a shaping step of shaping a reinforced aluminosilicate glass substrate obtained in step S101 into a curved plate shape by heating the reinforced aluminosilicate glass substrate at a shaping temperature of about 250° C. to about 900° C. for about 20 minutes to about 300 minutes.

As shown in FIG. 4A, the protective substrate 201 has a first surface 201S1 and a second surface 201S2 opposite to the first surface 201S1. The protective substrate 201 provided in step S301 may be a curved substrate having a curved shape, wherein the first surface 201S1 of the protective substrate 201 may be a curved surface that is concave toward the second surface 201S2. At least one of the first surface 201S1 and the second surface 201S2 has a radius of curvature that is greater than or equal to 1 mm and less than or equal to 7000 mm. In some embodiments, the first surface 201S1 and the second surface 201S2 may have the same radius of curvature as shown in FIG. 4A, but the present disclosure is not limited thereto. In some embodiments, although not shown, the first surface 201S1 and/or the second surface 201S2 may have a radius of curvature that is greater than or equal to 1 mm and less than or equal to 7000 mm, while the other may have a radius of curvature of 0.

FIG. 4B is a cross-sectional view illustrating the intermediate structure of the electronic device 4 at the stage of step S302 in the manufacturing method 3 of the electronic device. Step S302 comprises forming a first preparatory layer 203′ on the first surface 201S1 of the protective substrate 201 obtained in step S301, as shown in FIG. 4B. Step S302 of forming the first preparatory layer in the manufacturing method 3 of the electronic device is substantially the same as step S102 of forming the first preparatory layer in the manufacturing method 1 of the electronic device, so it is not repeated here.

FIG. 4C is a cross-sectional view illustrating the intermediate structure of the electronic device 4 at the stage of step S303 in the manufacturing method 3 of the electronic device. The first preparatory layer 203′ formed in step S302 may be converted to a first functional layer 203(200F), such as an anti-glare layer, an anti-reactive layer, or a combination thereof, after performing the first heat treatment in step S303. In the embodiment in which step S301 of providing the protective substrate comprising a shaping step, the process temperature of the heat treatment for converting the preparatory layer to a functional layer may be lower than the shaping temperature of the shaping step. In this way, the curved degree of the protective substrate may be maintained during the heat treatment. The first functional layer obtained in step S303 and the first functional layer obtained in step S103 may have the same or similar materials, structures and/or properties, or may be formed by the same or similar processes, and are therefore not repeated herein.

FIG. 4D is a cross-sectional view illustrating the intermediate structure of the electronic device 4 at the stage of step S304 in the manufacturing method 3 of the electronic device. In step S304, a black matrix 205 is formed on the second surface 201S2 of the protective substrate 201. The protective substrate 201 is between the black matrix 205 and the first functional layer 203(200F), as shown in FIG. 4D. Step S304 of forming the black matrix in the manufacturing method 3 of the electronic device is substantially the same as step S104 of forming the black matrix in the manufacturing method 1 of the electronic device, so it is not repeated here.

FIG. 4E is a cross-sectional view illustrating the intermediate structure of the electronic device 4 at the stage of step S305 in the manufacturing method 3 of the electronic device. In step S305, the second functional layer 207(200F) is formed on the first surface 201S1 of the protective substrate 201. The first functional layer 203(200F) is between the second functional layer 207(200F) and the protective substrate 201, as shown in FIG. 4E. In some embodiments, examples of the second functional layer 207(200F) may comprise, but not limited to, an anti-glare layer, an anti-reflective layer, or a combination thereof. In some embodiments, the second functional layer 207(200F) comprises an anti-reflective layer. In some embodiments, the hardness of the second functional layer 207(200F) may be in a range from about 3H to 9H, e.g., from about 3H to 8H, from about 3H to 5H, from about 6H to 8H, or from about 6H to 9H. The second functional layer 207(200F) may have a thickness of about 10 nm to about 10 μm, a density of about 1.3 to about 2.3 g/cm³, and/or a porosity of about 10 to about 90%. In some embodiments, the second functional layer 207 (200F) comprises an oxide layer. In some embodiments, the second functional layer 207(200F) comprises silicon oxide (SiO₂) and niobium oxide (Nb₂O₅). In some embodiments, the second functional layer 207(200F) may be formed on the first surface 20151 of the protective substrate 201 by a needle coating process, a spray coating process, a spray evaporation process, an Ink-Jet printing coating process, a screen printing coating process, a relief/gravure printing coating process, a transfer printing coating process, a chemical vapor deposition process, a physical vapor deposition process, an atomic layer deposition process, a high density plasma chemical vapor deposition process, other suitable processes or a combination thereof, but the present disclosure is not limited thereto. In some embodiments, the second functional layer 207(200F) is in direct contact with the first functional layer 203(200F). In some embodiments, the second functional layer 207(200F) may not be in direct contact with the first functional layer 203(200F). For example, in some embodiments, step S305 of forming the second functional layer comprises forming a mixture of silicon oxide (SiO₂) and niobium oxide (Nb₂O₅) with a thickness of about 10 nm to 10 μm on the first functional layer 203(200F) as the second functional layer 207(200F) by a spray evaporation process. The spray evaporation process comprises a process temperature of about 100 to 200° C. and a process time of about 30 minutes to 120 minutes.

FIG. 4F is a cross-sectional view illustrating the intermediate structure of the electronic device 4 at the stage of step S306 in the manufacturing method 3 of the electronic device. In step S306, an anti-smudge layer 209 is formed on the second functional layer 207(200F). The second functional layer 207(200F) is between the anti-smudge layer 209 and the first functional layer 203(200F), as shown in FIG. 4F. Step S306 of forming the anti-smudge layer in the manufacturing method 3 of the electronic device is substantially the same as step S107 of forming the anti-smudge layer in the manufacturing method 1 of the electronic device, so it is not repeated here. A substrate assembly 40 comprising the protective substrate and the functional layer formed thereon is obtained after completing step S306. The substrate assembly 40 may have high hardness, good wear resistance and/or good impact resistance due to the high hardness, high density, low porosity of the first functional layer.

FIG. 4G is a cross-sectional view illustrating the intermediate structure of the electronic device 4 at the stage of step S307 in the manufacturing method 3 of the electronic device. As shown in FIG. 4G, in step S307, the electronic module 10 is disposed on the second surface 201S2 of the protective substrate 201. The black matrix 205 is between the protective substrate 201 and the electronic module 10. In step S307, the electronic module 10 may be disposed on the second surface 201S2 of the protective substrate 201 by laminating, but the present disclosure is not limited thereto. The electronic device 4 may be obtained after completing step S307. In some embodiments, the electronic device 4 may have a curvature center (e.g., the curvature center of the first surface 201S1), and the distance between the curvature center and the electronic module 10 is greater than the distance between the curvature center and the substrate assembly 40. The electronic device 4 comprises a substrate assembly 40 having high hardness, good wear resistance and/or good impact resistance. Therefore, the electronic module 10 in the disclosed electronic device 4 is less susceptible to damage than the conventional electronic devices. As shown in FIG. 4G, the functional layer 200F is provided on the first surface 201S1 of the protective substrate 201. The first surface 201S1 of the protective substrate 201 has a radius of curvature that is greater than or equal to 1 mm and less than or equal to 7000 mm.

According to some embodiments, the manufacturing process of FIG. 3 could be used without providing a protective substrate with a curved shape in step S301. A protective substrate with a flat shape may be provided in step S301. Accordingly, the electronic device may have the same structure as in FIG. 4G, except that it has a flat shape instead of a curved shape.

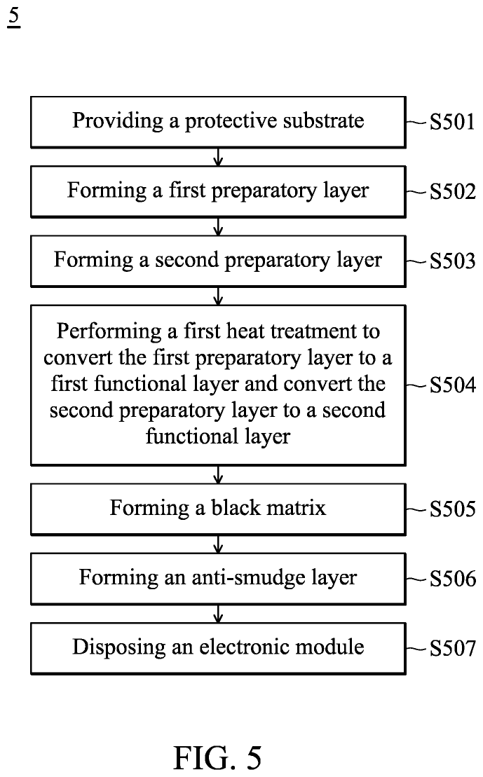

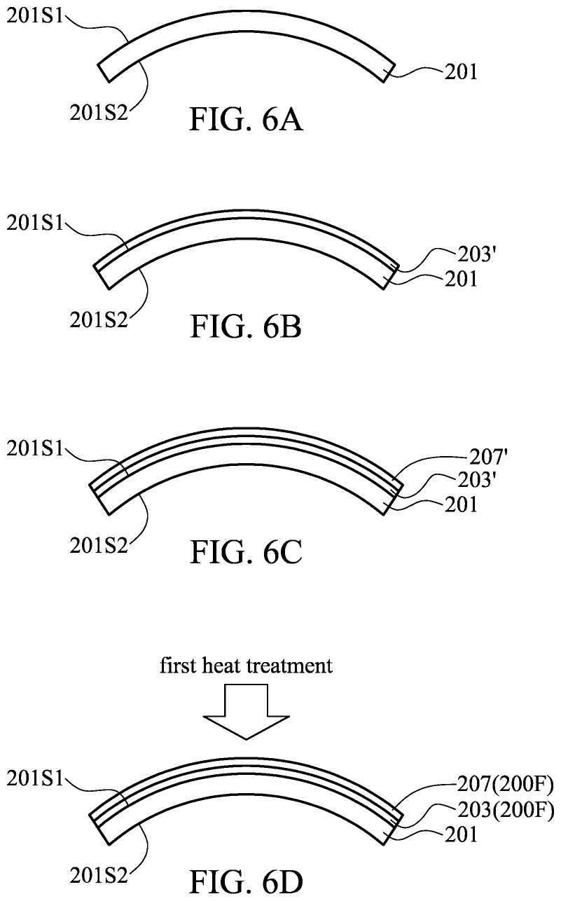

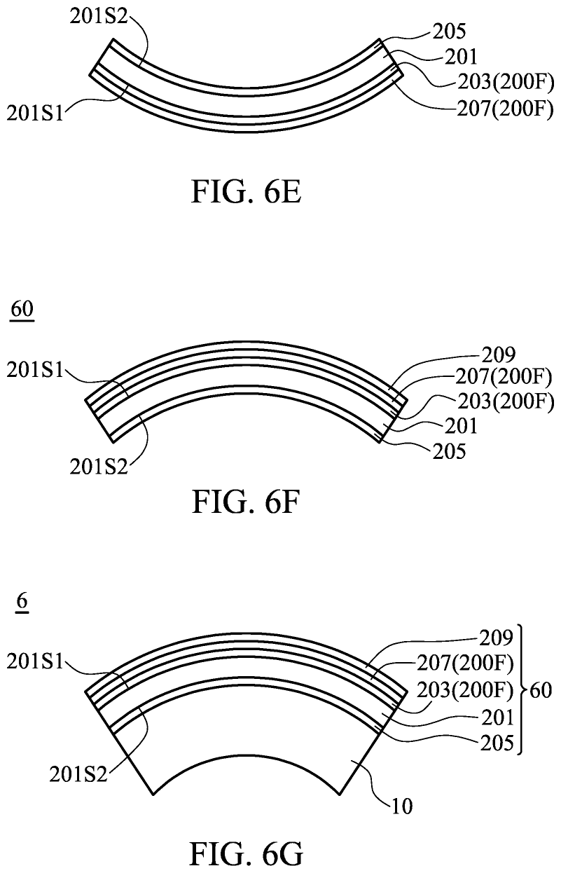

FIG. 5 is a flowchart illustrating a manufacturing method 5 of an electronic device according to some embodiments of the present disclosure. The manufacturing method 5 of the electronic device shown in FIG. 5 is mainly different from the manufacturing method 1 of the electronic device shown in FIG. 1 in that, in the manufacturing method 5 of the electronic device shown in FIG. 5, the first preparatory layer and the second preparatory layer are formed before the step of performing the first heat treatment, and the first preparatory layer and the second preparatory layer are converted into the first functional layer and the second functional layer simultaneously by the first thermal treatment. FIGS. 6A to 6G illustrate cross-sectional views of intermediate structures of the electronic device 6 corresponding to the stages of each step in the manufacturing method 5 of the electronic device shown in FIG. 5. Hereinafter, the present disclosure will be described with reference to FIG. 5 and FIGS. 6A to 6G. The following mainly describes the main differences between this embodiment and the preceding embodiments. The descriptions of the same or similar elements can be referred to the preceding embodiment and will not be repeated here.

As shown in FIG. 5, the manufacturing method 5 of an electronic device according to some embodiments of the present disclosure comprises step S501 of providing a protective substrate, step S502 of forming a first preparatory layer, step S503 of forming a second preparatory layer, step S504 of performing a first heat treatment to convert the first preparatory layer to a first functional layer and convert the second preparatory layer to a second functional layer, step S505 of a black matrix, step S506 of forming an anti-smudge layer, and step S507 of disposing an electronic module.

FIG. 6A is a cross-sectional view illustrating the intermediate structure of the electronic device 6 at the stage of step S501 in the manufacturing method 5 of the electronic device. In some embodiments, compared to step S101, step S501 of providing the protective substrate may further comprise a shaping step to form the protective substrate into a curved shape. For example, the protective substrate 201 provided in step S501 may be a curved substrate having a curved shape, wherein the first surface 201S1 of the protective substrate 201 may be a curved surface projecting in a direction away from the second surface 201S2. Step S501 of providing the protective substrate may comprise a shaping step of shaping a reinforced aluminosilicate glass substrate obtained in step S101 into a curved plate shape by heating the reinforced aluminosilicate glass substrate at a shaping temperature of about 250° C. to about 900° C. for about 20 minutes to about 300 minutes. The first surface 201S1, the second surface 201S2, or both may have a radius of curvature of greater than or equal to 1 mm and less than or equal to 7000 mm. In some embodiments, the first surface 201S1 and the second surface 201S2 may have the same radius of curvature, but the present disclosure is not limited thereto. In some embodiments, although not shown, the first surface 201S1 or the second surface 201S2 may have a radius of curvature of greater than or equal to 1 mm and less than or equal to 7000 mm, while the other may have a radius of curvature of 0.

FIG. 6B is a cross-sectional view illustrating the intermediate structure of the electronic device 6 at the stage of step S502 in the manufacturing method 5 of the electronic device. Step S502 comprises forming a first preparatory layer 203′ on the first surface 201S1 of the protective substrate 201 obtained in step S301, as shown in FIG. 6B. Step S302 of forming the first preparatory layer in the manufacturing method 5 of the electronic device is substantially the same as step S102 of forming the first preparatory layer in the manufacturing method 1 of the electronic device, so it is not repeated here.

FIG. 6C is a cross-sectional view illustrating the intermediate structure of the electronic device 6 at the stage of step S503 in the manufacturing method 5 of the electronic device. In step S503, the second preparatory layer 207′ is formed on the first surface 201S1 of the protective substrate 201. The first preparatory layer 203′ is between the second preparatory layer 207′ and the protective substrate 201, as shown in FIG. 6C. Step S503 of forming the second preparatory layer in the manufacturing method 5 of the electronic device is substantially the same as step S105 of forming the second preparatory layer in the manufacturing method 1 of the electronic device, so it is not repeated here.

FIG. 6D is a cross-sectional view illustrating the intermediate structure of the electronic device 6 at the stage of step S504 in the manufacturing method 5 of the electronic device. The first preparatory layer 203′ formed in step S502 may be converted to a first functional layer 203(200F), such as an anti-glare layer, an anti-reactive layer, or a combination thereof, and the second preparatory layer 207′ formed in step S503 may be converted to a second functional layer 207(200F), such as an anti-glare layer, an anti-reactive layer, or a combination thereof after performing the first heat treatment in step S504. The first functional layer obtained in step S504 and the first functional layer obtained in step S103 may have the same or similar materials, structures and/or properties, or may be formed by the same or similar processes, and are therefore not repeated herein. The second functional layer obtained in step S504 and the second functional layer obtained in step S106 may have the same or similar materials, structures and/or properties, or may be formed by the same or similar processes, and are therefore not repeated herein.

FIG. 6E is a cross-sectional view illustrating the intermediate structure of the electronic device 6 at the stage of step S505 in the manufacturing method 5 of the electronic device. In step S505, a black matrix 205 is formed on the second surface 201S2 of the protective substrate 201. The protective substrate 201 is between the black matrix 205 and the first functional layer 203(200F), as shown in FIG. 6E. Step S505 of forming the black matrix in the manufacturing method 5 of the electronic device is substantially the same as step S104 of forming the black matrix in the manufacturing method 1 of the electronic device, so it is not repeated here.

FIG. 6F is a cross-sectional view illustrating the intermediate structure of the electronic device 6 at the stage of step S506 in the manufacturing method 5 of the electronic device. In step S506, an anti-smudge layer 209 is formed on the second functional layer 207(200F). The second functional layer 207(200F) is between the anti-smudge layer 209 and the first functional layer 203(200F), as shown in FIG. 6F. Step S506 of forming the anti-smudge layer in the manufacturing method 5 of the electronic device is substantially the same as step S107 of forming the anti-smudge layer in the manufacturing method 1 of the electronic device, so it is not repeated here. A substrate assembly 60 comprising the protective substrate and the functional layer formed thereon is obtained after completing step S506. The substrate assembly 60 may have high hardness, good wear resistance and/or good impact resistance due to the high hardness, high density, low porosity of the first functional layer and the second functional layer.

FIG. 6G is a cross-sectional view illustrating the intermediate structure of the electronic device 6 at the stage of step S507 in the manufacturing method 5 of the electronic device. As shown in FIG. 6G, in step S507, the electronic module 10 is disposed on the second surface 201S2 of the protective substrate 201. The black matrix 205 is between the protective substrate 201 and the electronic module 10. In step S507, the electronic module 10 may be disposed on the second surface 201S2 of the protective substrate 201 by laminating, but the present disclosure is not limited thereto. The electronic device 6 may be obtained after completing step S507. In some embodiments, the electronic device 6 may have a curvature center (e.g., the curvature center of the first surface 201S1), and the distance between the curvature center and the electronic module 10 is smaller than the distance between the curvature center and the substrate assembly 60. The electronic device 6 comprises a substrate assembly 60 having high hardness, good wear resistance and/or good impact resistance.

According to some embodiments, the manufacturing process of FIG. 5 could be used without providing a protective substrate with a curved shape in step S501. A protective substrate with a flat shape may be provided in step S501. Accordingly, the electronic device may have the same structure as in FIG. 6G, except that it has a flat shape instead of a curved shape.

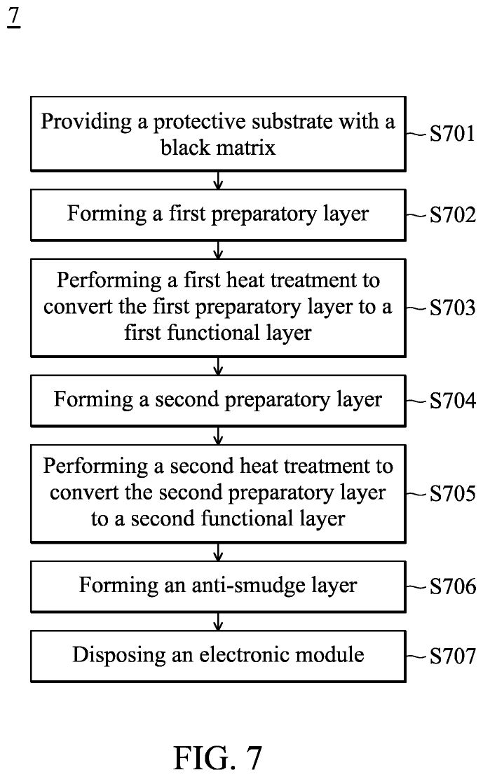

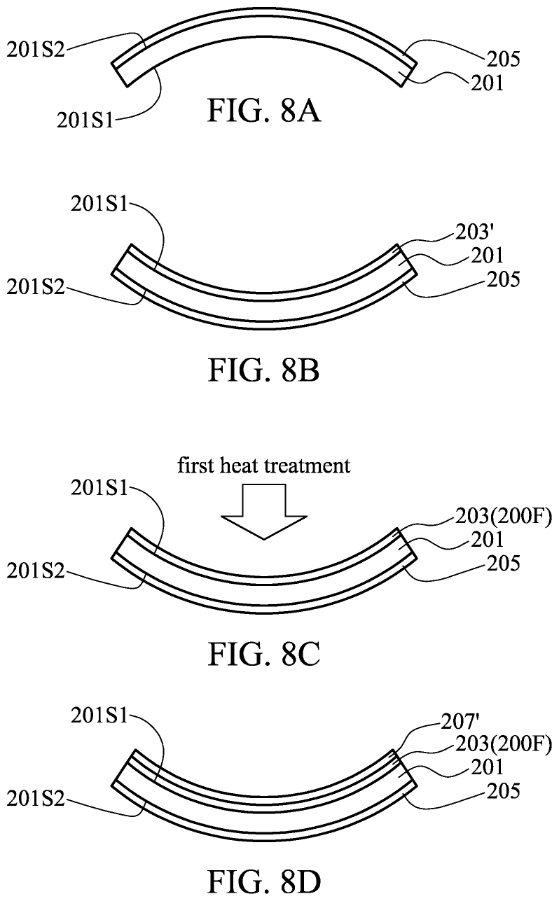

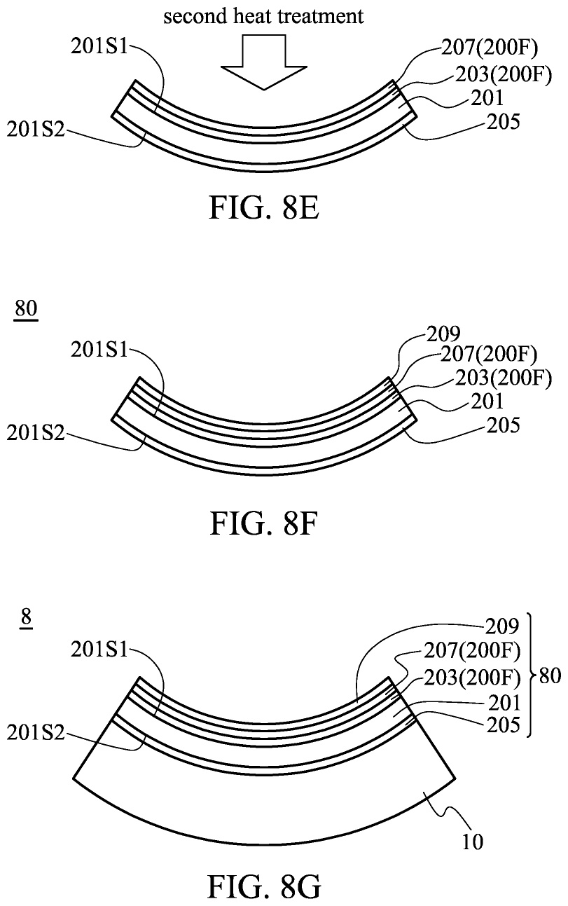

FIG. 7 is a flowchart illustrating a manufacturing method 7 of an electronic device according to some embodiments of the present disclosure. FIGS. 8A to 8G illustrate cross-sectional views of intermediate structures of the electronic device 8 corresponding to the stages of each step in the manufacturing method 7 of the electronic device shown in FIG. 7. The manufacturing method of the electronic device shown in FIG. 7 is mainly different from the manufacturing method of the electronic device shown in FIG. 1 in that, the black matrix is formed before forming the functional layer 200F by the heat treatment. In particular, as shown in FIG. 7, the manufacturing method 7 of an electronic device according to some embodiments of the present disclosure comprises step S701 of providing a protective substrate with a black matrix, step S702 of forming the first preparatory layer, step S703 of performing a first heat treatment to convert the first preparatory layer to a first functional layer, step S704 of forming the second preparatory layer, step S705 of performing a second thermal treatment to convert the second preparatory layer to a second functional layer, step S706 of forming the anti-smudge layer, and step S707 of disposing an electronic module.

FIG. 8A is a cross-sectional view illustrating the intermediate structure of the electronic device 8 at the stage of step S701 in the manufacturing method 7 of the electronic device. In some embodiments, compared to step S101, step S701 of providing a protective substrate with a black matrix may further comprise a step of forming a black matrix and a shaping step. The protective substrate 201 provided in step S701 may be a curved substrate having a curved shape, wherein the first surface 201S1 of the protective substrate 201 may be a curved surface that is concave toward the second surface 201S2. For example, step S701 of providing the protective substrate with a black matrix may comprise a step of forming the black matrix at a reinforced aluminosilicate glass substrate obtained in step S101 and a shaping step of shaping the reinforced aluminosilicate glass substrate with the black matrix into a curved plate shape by heating the reinforced aluminosilicate glass substrate with the black matrix at a shaping temperature of about 250° C. to about 900° C. for about 20 minutes to about 300 minutes. In some embodiments, the shaping step may be performed prior to the step of forming the black matrix. In other embodiments, the step of forming the black matrix may be performed prior to the cutting step. In yet other embodiments, the shaping step may be omitted.

FIG. 8B is a cross-sectional view illustrating the intermediate structure of the electronic device 8 at the stage of step S702 in the manufacturing method 7 of the electronic device. Step S702 comprises forming the first preparatory layer 203′ on the first surface 201S1 opposite to the second surface 201S2 of the protective substrate 201 on which the black matrix 205 has been formed, as shown in FIG. 8B. Step S702 of forming the first preparatory layer in the manufacturing method 7 of the electronic device is substantially the same as step S102 of forming the first preparatory layer in the manufacturing method 1 of the electronic device, so it is not repeated here.

FIG. 8C is a cross-sectional view illustrating the intermediate structure of the electronic device 8 at the stage of step S703 in the manufacturing method 7 of the electronic device. The first preparatory layer 203′ formed in step S702 may be converted to a first functional layer 203(200F), such as an anti-glare layer, an anti-reactive layer, or a combination thereof, after performing the first heat treatment in step S703. The first functional layer obtained in step S703 and the first functional layer obtained in step S103 may have the same or similar materials, structures and/or properties, or may be formed by the same or similar processes, and are therefore not repeated herein.

FIG. 8D is a cross-sectional view illustrating the intermediate structure of the electronic device 8 at the stage of step S704 in the manufacturing method 7 of the electronic device. In step S704, the second preparatory layer 207′ is formed on the first surface 201S1 of the protective substrate 201. The first functional layer 203(200F) is between the second preparatory layer 207′ and the protective substrate 201, as shown in FIG. 8D. Step S704 of forming the second preparatory layer in the manufacturing method 7 of the electronic device is substantially the same as step S105 of forming the second preparatory layer in the manufacturing method 1 of the electronic device, so it is not repeated here.

FIG. 8E is a cross-sectional view illustrating the intermediate structure of the electronic device 8 at the stage of step S705 in the manufacturing method 7 of the electronic device. The second preparatory layer 207′ formed in step S704 may be converted to a second functional layer 207(200F), such as an anti-glare layer, an anti-reactive layer, or a combination thereof, after performing the second heat treatment in step S705. The second functional layer obtained in step S705 and the second functional layer obtained in step S106 may have the same or similar materials, structures and/or properties, or may be formed by the same or similar processes, and are therefore not repeated herein.

FIG. 8F is a cross-sectional view illustrating the intermediate structure of the electronic device 8 at the stage of step S706 in the manufacturing method 7 of the electronic device. In step S706, an anti-smudge layer 209 is formed on the second functional layer 207(200F). The second functional layer 207(200F) is between the anti-smudge layer 209 and the first functional layer 203(200F), as shown in FIG. 8F. Step S706 of forming the anti-smudge layer in the manufacturing method 7 of the electronic device is substantially the same as step S107 of forming the anti-smudge layer in the manufacturing method 1 of the electronic device, so it is not repeated here. A substrate assembly 80 comprising the protective substrate and the functional layer formed thereon is obtained after completing step S706. The substrate assembly 80 may have high hardness, good wear resistance and/or good impact resistance due to the high hardness, high density, low porosity of the first functional layer and the second functional layer.

FIG. 8G is a cross-sectional view illustrating the intermediate structure of the electronic device 8 at the stage of step S707 in the manufacturing method 7 of the electronic device. As shown in FIG. 8G, in step S707, the electronic module 10 is disposed on the second surface 201S2 of the protective substrate 201. The black matrix 205 is between the protective substrate 201 and the electronic module 10. In step S707, the electronic module 10 may be disposed on the second surface 201S2 of the protective substrate 201 by laminating, but the present disclosure is not limited thereto. The electronic device 8 may be obtained after completing step S707. In some embodiments, the electronic device 8 may have a curvature center (e.g., the curvature center of the first surface 201S1), and the distance between the curvature center and the electronic module 10 is greater than the distance between the curvature center and the substrate assembly 80. The electronic device 8 comprises a substrate assembly 80 having high hardness, good wear resistance and/or good impact resistance.

According to some embodiments, the manufacturing process of FIG. 7 could be used without providing a protective substrate with a curved shape in step S701. A protective substrate with a flat shape may be provided in step S701. Accordingly, the electronic device may have the same structure as in FIG. 8G, except that it has a flat shape instead of a curved shape.

The above manufacturing methods shown in FIGS. 1, 3, 5, and/or 7 are used as an example to illustrate the present disclosure. The manufacturing method of the electronic device of the present disclosure is not limited to the manufacturing methods of the electronic device shown in FIGS. 1, 3, 5, and/or 7. In some embodiments, the steps in the manufacturing method of the electronic device of the present disclosure may be replaced with other steps, and the manufacturing method of the electronic device of the present disclosure may further comprise other steps or omit some steps. In some embodiments, the steps in the manufacturing methods of the electronic device shown in FIGS. 1, 3, 5, and/or 7 may be used interchangeably. For example, the protective substrate 201 provided in step S101 of the manufacturing method 1 of the electronic device shown in FIG. 1 may have the shape as shown in FIG. 4A or FIG. 6A. In other embodiments, the order of implementation of the steps in the manufacturing method of the electronic device disclosed herein may be varied as long as the anti-smudge layer is formed after all of the heat treatment. For example, in some embodiments, step S304 of forming the black matrix in the manufacturing method 3 of the electronic device shown in FIG. 3 may be performed before step S303 of performing the first heat treatment.

As described above, in the electronic device disclosed above, the functional layer having a hardness in a range of about 4H to 9H is disposed on the protective substrate. In the manufacturing method of the electronic device of the present disclosure, the preparatory layer is converted into the functional layer after performing the heat treatment on the preparatory layer. The present disclosure provides a high hardness substrate assembly without affecting the existing equipment used to form the electronic device and without adjusting the process parameters of the anti-smudge layer and/or anti-reflective layer. The present disclosure provides an electronic device that is impact resistant and/or has a long service life by forming the functional layer having a hardness in a range of about 4H to 9H on the protective substrate.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
an electronic module;
a protective substrate disposed on the electronic module; and
a functional layer disposed on the protective substrate, wherein the functional layer has a hardness in a range of 4H to 9H.

2. The electronic device as claimed in claim 1, wherein the functional layer has a density of 1.3 to 4.6 g/cm³.

3. The electronic device as claimed in claim 1, wherein the functional layer comprises an anti-glare layer, an anti-reflective layer, or a combination thereof.

4. The electronic device as claimed in claim 1, further comprising an anti-smudge layer disposed on the functional layer.

5. The electronic device as claimed in claim 1, wherein the protective substrate has a first surface and a second surface opposite to the first surface, the functional layer is on the first surface, and a radius of curvature of the first surface is greater than or equal to 1 mm and less than or equal to 7000 mm.

6. The electronic device as claimed in claim 1, wherein the functional layer comprises a first functional layer and a second functional layer.

7. The electronic device as claimed in claim 6, wherein the first functional layer has a density of about 1.3 to 2.7 g/cm³.

8. The electronic device as claimed in claim 6, wherein the first functional layer has a porosity of about 10 to 90%.

9. The electronic device as claimed in claim 6, wherein the first functional layer has a glossiness in a range of 40 to 140 GU.

10. The electronic device as claimed in claim 6, wherein reflectivity of the first functional layer is in a range of about 0.1 to 9%.

11. The electronic device as claimed in claim 6, wherein the second functional layer is a stack of insulating layers with different refractive indices.

12. A manufacturing method of an electronic device, comprising:
providing a protective substrate having a first surface and a second surface opposite to the first surface;
forming a preparatory layer on the first surface;
performing a heat treatment to convert the preparatory layer to a functional layer; and
disposing an electronic module on the second surface, wherein the heat treatment is performed at a temperature of 200° C. to 1200° C.

13. The manufacturing method as claimed in claim 12, wherein the heat treatment comprises an annealing process.

14. The manufacturing method as claimed in claim 13, wherein the annealing processes comprises a laser annealing process, a rapid annealing process, a plasma annealing process, an optical annealing process, a fluid annealing process, or a combination thereof.

15. The manufacturing method as claimed in claim 12, wherein the step of providing the protective substrate comprises a shaping step to form the protective substrate into a curved shape.

16. The manufacturing method as claimed in claim 15, wherein a process temperature of the heat treatment is lower than a shaping temperature of the shaping step.

17. The manufacturing method as claimed in claim 12, further comprising forming an anti-smudge layer on the functional layer.

18. The manufacturing method as claimed in claim 12, further comprising forming a black matrix on the second surface after the step of performing the heat treatment.

19. The manufacturing method as claimed in claim 18, further comprising performing another heat treatment after the step of forming the black matrix.

20. The manufacturing method as claimed in claim 12, wherein a hardness of the functional layer is higher than that of the preparatory layer.
